(19) United States
(12) Patent Application Publication
(10) Pub. No.: US 2005/0161937 A1
(43) Pub. Date: Jul. 28, 2005

(54) Method and apparatus for printing a label from a photographic media tab

(76) Inventor: David E. Austin, Portland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/767,590

(22) Filed: Jan. 28, 2004

(51) Int. Cl. B42D 15/00

(52) U.S. Cl. 283/105

(57) ABSTRACT

A method of printing an image identifier from a media tab, comprising the steps of: printing at least a portion of a first image on a first section of a media; printing at least a portion of a second image on a second section of the media such that the first and second sections are detachably connected; and detaching the second section from the first section such that the second image can be utilized as an identifier for the first image.

### FIELD OF THE INVENTION

This invention relates to a method of printing an image identifier on a media tab, comprising the steps of: printing at least a portion of a first image on a first section of a media; printing at least a portion of a second image on a second section of the media such that the first and second sections are detachably connected; and detaching the second section from the first section such that the second image can be utilized as an identifier for the first image.

### DESCRIPTION OF THE RELATED ART

Prior to the present invention, as set forth in general terms above and more specifically below, it is known, in the printing art, to use the tab on the photo paper to handle the photo without smudging the ink. The tab is only utilized briefly to handle the picture for a few minutes while the ink is drying. It is important not to smudge the print while it is wet or when handling it, but the tab becomes a waste product and is used only for a short period of time. Consequently, a more advantageous system, then, would be provided if the tab could be transformed into a label that can be separated, but does not have to be separated from the picture in order to provide a label for that picture.

It is apparent from the above that there exists a need in the art for a tab that could be transformed into a label that can be separated (or not) from the picture in order to provide a label for that picture. It is a purpose of this invention to fulfill this and other needs in the art in a manner more apparent to the skilled artisan once given the following disclosure.

### SUMMARY OF THE INVENTION

Generally speaking, an embodiment of this invention fulfills these needs by providing a method of printing an image identifier from a media tab, comprising the steps of: printing at least a portion of a first image on a first section of a media; printing at least a portion of a second image on a second section of the media such that the first and second sections are detachably connected; and detaching the second section from the first section such that the second image can be utilized as an identifier for the first image.

In certain preferred embodiments, the first image can be a photograph. Also, the media can be photographic media. Finally, the second section can be utilized as an identifier/label for the photograph.

In another further preferred embodiment, a photograph and tab are printed on the same sheet of photographic media such that the tab can be detached, and utilized as a label for the photograph.

The preferred method of printing an identifier from a media tab, according to various embodiments of the present invention, offers the following advantages: a unique identifier for the photograph; ease of use; excellent print quality characteristics; and excellent economy/reduced waste. In fact, in many of the preferred embodiments, these factors of a unique identifier for the photograph, ease of use, and excellent print quality characteristics are optimized to an extent that is considerably higher than heretofore achieved in prior, known methods for printing image identifiers.

The above and other features of the present invention, which will become more apparent as the description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a flowchart of a method for printing an image identifier from a media tab, according to one embodiment of the present invention;

FIG. 2 is a schematic illustration of a printed photograph and a printed tab assembly; prior to removal of the tab, according to another embodiment of the present invention;

FIG. 3 is a schematic illustration of the printed photograph and the printed label components, after removal of the tab, according to still another embodiment of the present invention; and

FIG. 4 is a schematic illustration of a photo album containing printed photographs and printed labels, according to yet another embodiment of the present invention.

### DETAILED DESCRIPTION OF THE INVENTION

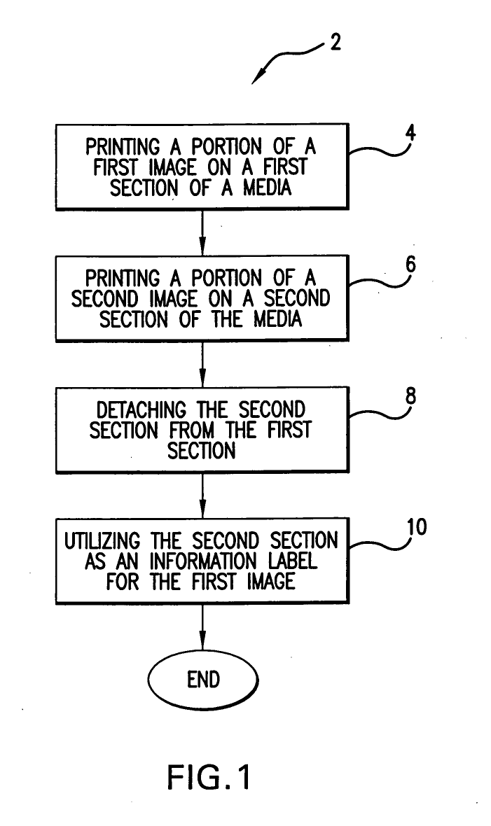

With reference first to FIG. 1, there is illustrated one preferred embodiment for use of the concepts of this invention. FIG. 1 illustrates method 2 for printing an image identifier from a media tab. Method 2 includes, in part, the steps of: printing an image, such as a photograph, on a media (step 4); printing information about the image on a second portion of the media, such as a tab (step 6); removing the tab from the photograph (step 8); and utilizing the tab as an information/identifier label for the image (step 10).

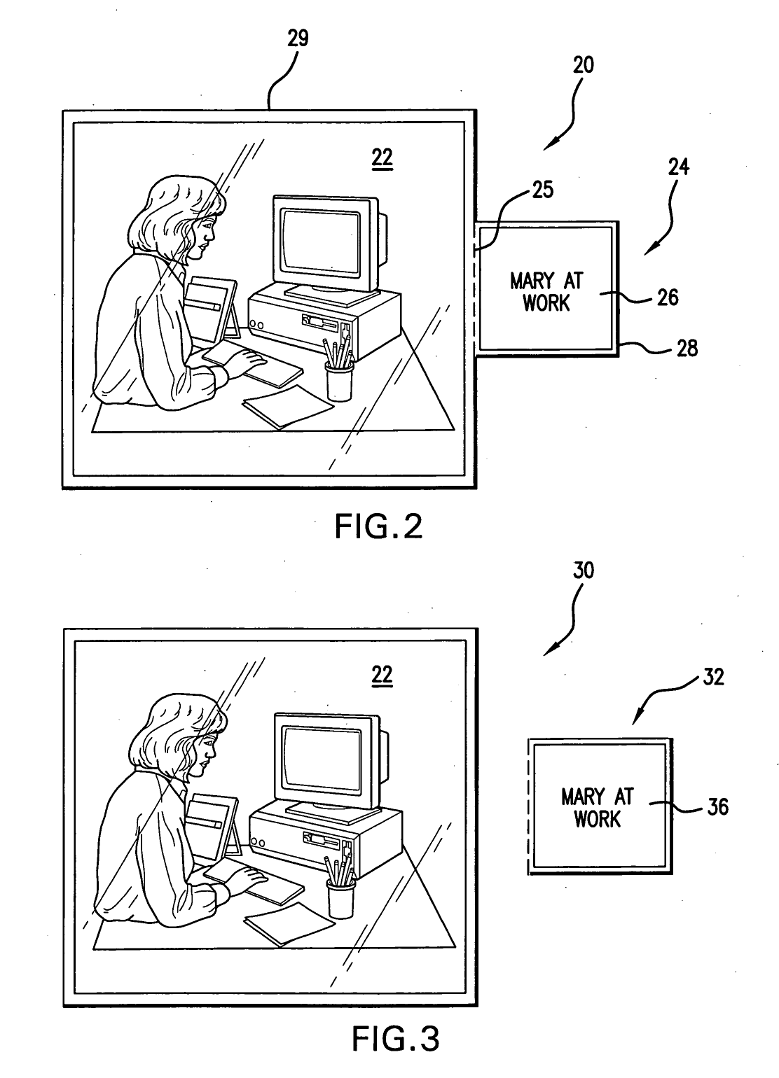

With respect to step 4, it is to be understood that only a portion of the image could be printed prior to commencing the printing of the information about the image on the second portion of media. However, it is to be understood that both the image 22 (FIG. 2) and the tab image 26 could be printed at the same time or sequentially. Also, while the preferred media is photographic media, any other suitable media could be employed that would include a first section for a first image and a second section for a second image such that the second image provides an information/identifier label for the first image and the second section is detachable from the first section.

With respect to step 6, it is to be understood that only a portion of the information about the image in step 4 could be printed prior to commencing the printing of the image in step 4.

With respect to FIG. 2, a schematic illustration of a photographic assembly 20 is shown. Assembly 20 includes, in part, image 22, tab 24, perforated line 25, tab image 26, tab edge 28, and image edge 29. Preferably, image 22 is a photographic image that has been printed upon photographic media. Preferably, tab 24 is detachably connected to image 22 along perforated line 25. Preferably, tab image 26 is any suitable image that can be used to identify image 22. Preferably, tab edge 28 and image edge 29 are conventionally utilized by an imaging device (not shown) in order to form image 22 and tab image 26. However, it is to be understood that other portions of assembly 20 can be used in order to form image 22 and tab image 26.

With respect to FIG. 3, a schematic illustration of photograph/label components 30 is shown. Assembly 30 includes in part, image 22, label 32, and label image 36. As discussed above, image 22 and tab 24 (FIG. 2) are connected along perforated line 25. After image 22 and tab image 26 are formed, tab 24 is removed from photographic assembly 20 along perforated line 25 to create label 32 having label image 36.

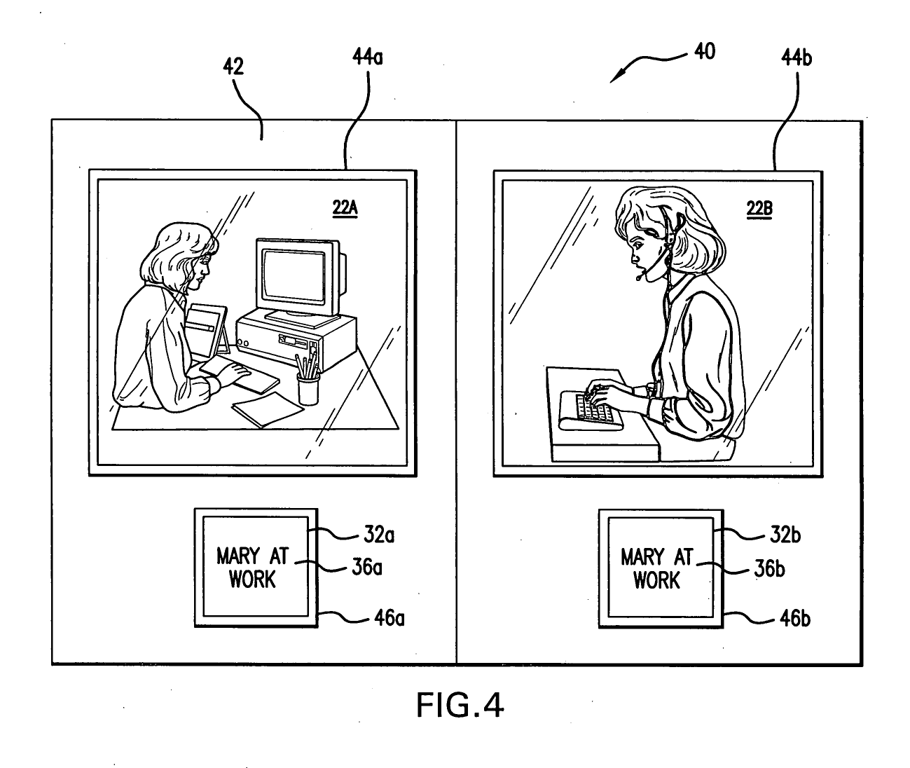

With respect to FIG. 4, photo album 40 is illustrated. Photo album 40 includes, in part, conventional photo album pages 42, conventional photo album image retainers 44a and 44b, and photo album label retainers 46a and 46b. As can be seen in FIG. 4, after image 22a is separated from label 32a, image 22a is conventionally located within photo album image retainer 44a. Also, label 32a is located within photo album label retainer 46a such that label image 36a can provide information about image 22a. As can be further seen in FIG. 4, label 32b having label image 36b can then be used to provide information about image 22b. It is to be understood that label 32 could be removed and conventionally attached to the back of image 22. Also, it is to be understood that label 32 does not have to be removed from image 22. The image 22 and the label 32 could be merely inserted into photo album image retainer 44.

It is to be understood that the flowchart of the Figures shows the architecture, functionality, and operation of one implementation of the present invention. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction-execution system, apparatus or device such as a computer/processor based system, processor-containing system or other system that can fetch the instructions from the instruction-execution system, apparatus or device, and execute the instructions contained therein. In the context of this disclosure, a “computer-readable medium” can be any means that can store, communicate, propagate or transport a program for use by or in connection with the instruction-execution system, apparatus or device. The computer-readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc. It is to be understood that the computer-readable medium could even be paper or another suitable medium upon which the program is printed, as the program can be electronically captured, via, for instance, optical scanning of the paper or other medium, then compiled, interpreted or otherwise processed in a single manner, if necessary, and then stored in a computer memory.

Those skilled in the art will understand that various embodiment of the present invention can be implemented in hardware, software, firmware or combinations thereof. Separate embodiments of the present invention can be implemented using a combination of hardware and software or firmware that is stored in memory and executed by a suitable instruction-execution system. If implemented solely in hardware, as in an alternative embodiment, the present invention can be separately implemented with any or a combination of technologies which are well known in the art (for example, discrete-logic circuits, application-specific integrated circuits (ASICs), programmable-gate arrays (PGAs), field-programmable gate arrays (FPGAs), and/or other later developed technologies. In preferred embodiments, the present invention can be implemented in a combination of software and data executed and stored under the control of a computing device.

It will be well understood by one having ordinary skill in the art, after having become familiar with the teachings of the present invention, that software applications may be written in a number of programming languages now known or later developed.

Although the flowchart of FIG. 1 shows a specific order of execution, the order of execution may differ from that which is depicted. For example, the order of execution of two or more blocks may be scrambled relative to the order shown. Also, two or more blocks shown in succession in FIG. 1 may be executed concurrently or with partial concurrence. All such variations are within the scope of the present invention.

Once given the above disclosure, many other features, modifications or improvements will become apparent to the skilled artisan. Such features, modifications or improvements are, therefore, considered to be a part of this invention, the scope of which is to be determined by the following claims.

1. A method of printing an image identifier from a media tab, comprising the steps of:
printing at least a portion of a first image on a first section of a media;
printing at least a portion of a second image on a second section of said media such that said first and second sections are detachably connected; and
detaching said second section from said first section such that said second image can be utilized as an identifier for said first image.

2. The method, as in claim 1, wherein said steps of printing said first and second images is further comprised of the step of:
utilizing a tab edge and an image edge to print said first and second images.

3. The method, as in claim 1, wherein said first and second sections are detachably connected along a perforated line.

4. An image assembly, comprising:
a first image substantially located on a first section of a media; and
a second image substantially located on a second section of said media such that said first and second sections are detachably connected and said second image can be used as an identifier for said first image.

5. The image assembly, as in claim 4, wherein said first image is further comprised of:
a photograph.

6. The image assembly, as in claim 4, wherein said second image is further comprised of:
a tab image.

7. The image assembly, as in claim 4, wherein said first and second sections are detachably connected along a perforated line.

8. The image assembly, as in claim 4, wherein said second section is further comprised of:
a label.

9. A photograph/label assembly, comprising:
a photograph substantially located on a first section of a media; and
a second image substantially located on a second section of said media such that said first and second sections are detachably connected and said second image can be used as an identifier for said first image.

10. The photograph/label assembly, as in claim 9, wherein said second section is further comprised of:
a label.

11. The photograph/label assembly, as in claim 9, wherein said first and second sections are detachably connected along a perforated line.

12. A method of printing an image identifier from a media tab, comprising the steps of:
a printing means for printing at least a portion of a first image on a first section of a media;
a printing means for printing at least a portion of a second image on a second section of said media such that said first and second sections are detachably connected; and
a means for detaching said second section from said first section such that said second image can be utilized as an identifier for said first image.

13. The method, as in claim 12, wherein said steps of printing said first and second images is further comprised of the step of:
a means for utilizing a tab edge and an image edge to print said first and second images.

14. An article of manufacture, comprising a program storage medium having computer readable program code means embodied therein, for causing a method of printing an image identifier from a media tab, comprising the steps of:
printing at least a portion of a first image on a first section of a media;
printing at least a portion of a second image on a second section of said media such that said first and second sections are detachably connected; and
detaching said second section from said first section such that said second image can be utilized as an identifier for said first image.

15. The method, as in claim 14, wherein said steps of printing said first and second images is further comprised of the step of:
utilizing a tab edge and an image edge to print said first and second images.
